(19) United States
(12) Patent Application Publication
(10) Pub. No.: US 2005/0271793 A1
(43) Pub. Date: Dec. 8, 2005

(54) A RESISTANT STARCH AND PROCESS FOR THE PRODUCTION THEREOF

(75) Inventor: Joseph K. Carmosino, Lenexa, KS (US)

Correspondence Address: BLACKWELL SANDERS PEPER MARTIN LLP, 720 OLIVE STREET, SUITE 2400, ST. LOUIS, MO, 63101, US

(73) Assignee: MANILDRA MILLING CORPORATION, Shawnee Mission, KS (US)

(21) Appl. No.: 10/908,995

(22) Filed: Jun. 3, 2005

Related U.S. Application Data
(60) Provisional application No. 60/521,610, filed on Jun. 4, 2004.

(51) Int. Cl. C08B 33/02; A23L 1/05

(52) U.S. Cl. 426/661; 536/109

(57) ABSTRACT

A modified starch and its method of production are provided. A phosphorylated starch is produced from an acid modified starch starting material. The phosphorylated starch has a resistance to enzyme digestion of at least about 40%. The phosphorylated starch is made from a native starch that is first acid modified.

### CROSS REFERENCE TO RELATED APPLICATION

This application is a non-provisional application based on provisional patent application Ser. No. 60/521,610 filed Jun. 4, 2004, the disclosure of which is incorporated herein by reference.

### BACKGROUND OF INVENTION

Modified starches have been made for many decades. At least as early as the 1950's, starches were modified in order to provide new properties such as for use as thickening agents, dusting powders and paper additives. Early patents such as U.S. Pat. Nos. 2,801,242 and 3,021,222, issued to Kerr et al. disclose basic process as for modifying native starches. Kerr et al. teach that the higher the temperature, the longer the reaction time, the higher the pH, and the more reactant used, the higher the degree of crosslinking or the formation of distarch phosphate esters. The apparently most highly crosslinked or phosphorylated starch was that produced in Example 6 of the '242 patent which was useful as a dusting starch for surgical gloves which was resistant to autoclave conditions without gelatinizing. Kerr et al. issued several additional patents that reiterate and expand the phosphorylation process. It was also disclosed by Kerr et al. that the addition of a compound to provide a sodium ion would also enhance the phosphorylation reaction.

Research has been done since the 1970's to categorize starches by their digestibility or resistance. The concern appeared to be over the reduction of calories. There was also a desire to be able to list modified and unmodified starch in the ingredient listings as dietary fiber which would mean that they would have to be resistant to enzyme digestion. It is taught that chemically modified starches are resistant starches and were categorized as RS₄. Public and scientific attention has recently been directed to low carbohydrate diets. The digestion of starch was reputed to have effects on the body and in particular it was noted that by retarding digestion of starch until some it was in the colon, could have beneficial health effects beyond low calories.

U.S. Pat. No. 5,855,946 was issued Jan. 5, 1999 to Seib et al. This patent discusses a method of modifying a native starch and the production of a modified starch which was resistant to digestion according to theory and as measured by AOAC test 992.16 (1995). This patent, like the Kerr et al. patents mentioned above, taught that the higher the temperature, the longer the reaction time, the higher the pH and the more the reagent used, the greater the degree of phosphorylation and hence crosslinking. The Seib et al. patent also provides a summary of the prior art.

### SUMMARY OF THE INVENTION

The present invention provides a process for producing modified starch with resistance to enzyme digestion such as measured by FDA test AOAC 991.43 for total dietary fiber. The process of the invention includes the steps of first modifying native starch (herein “starch” or “native starch”), after which the initially modified native starch (initially modified starch) is phosphorylated to form phosphorylated starch (herein “modified starch”) to produce the desired degree of resistance to enzyme digestion. The phosphorylation process is conducted under conditions of time, temperature, amount of phosphorylating reactant, pH and optionally added reaction enhancers, to achieve the desire degree of resistance. After the phosphorylating reaction is completed, the modified starch and water mixture is neutralized to an approximate neutral pH. The modified starch is washed to remove deleterious materials e.g., reactant and in particular, any phosphates in order to reduce the residual phosphorus. After washing, the modified starch is dried to the desired degree of water content.

The invention also involves the provision of a modified starch wherein the starch granules have been acid treated to provide a more porous starch granule exterior surface portion and wherein the starch contained within the granule is phosphorylated to provide digestion resistance.

### BRIEF DESCRIPTION OF DRAWINGS

FIG. 1 is a flow chart of one embodiment of the present invention showing a modified starch production process.

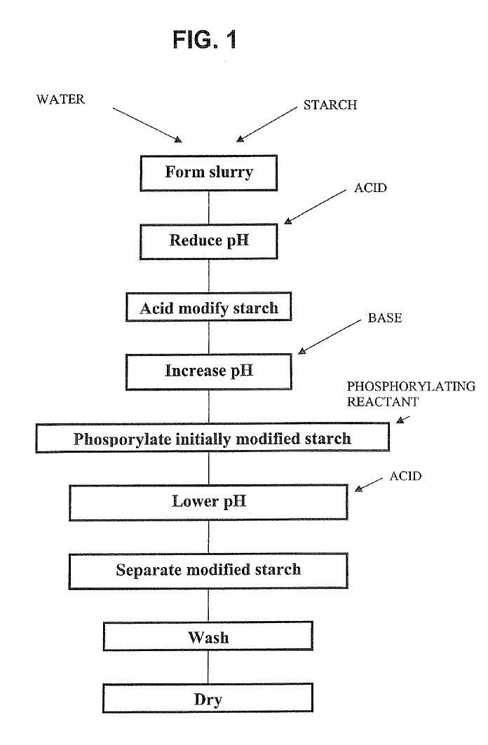

### DETAILED DESCRIPTION

A process for the production of modified starch includes generally, forming a slurry of water and starch, lowering the pH of the slurry, treating the starch for a reaction time period, increasing the pH of the slurry, adding a phosphorylating reactant to the now basic mixture (or optionally adding phosphoylation agent prior to adding base), phosphorylating the initially modified starch for a period of time adequate to reach the desired degree of resistance, neutralizing the phosphorylated starch, washing the neutralized phosphorylated starch to remove in particular phosphorus and drying the phosphorylated starch. If desired, a semi-moist process may be used as taught in Seib et al. '946.

The ingredients herein are expressed in terms of their percentage as added by weight of starch on a dry starch basis unless the amount included is otherwise expressed. All quantities are weight quantities unless otherwise expressed. A mixture of water, starch and acid is made. Preferably, the starch and water are mixed to form a slurry and acid is added, as for example hydrochloric acid or sulfuric acid, until the pH of the mixture is reduced to less than about 2 and preferably less than about 1.5. The native starch may include any suitable starch such as those derived from cereal grains, tubers, tapioca and mung bean, and any other suitable starch. Starch types may be used in combination if desired. The preferred starches are cereal grains of which corn and wheat starch are preferred. Of the tubers, potato starch may be used. Preferably, for bread, and bread-like and other items using wheat as a major component, wheat starch is a preferred starting material. All the materials added are used in the herein-described process should be food grade or adapted for ingestion by humans and/or other animals when the modified starch is to be used in food. Various regulatory schemes amongst the various countries will control what is acceptable for use in food products and such regulations are subject to change. The starting starch is exposed to the acid treatment for a period of time to change its properties. One method of monitoring property change is to check the viscosity of the starch being treated the starch being mixed with water at the beginning and then throughout the acid and phosphorylation treatment steps. The viscosity may be checked with a Brabender viscometer as is known in the art and may be checked under various conditions as desired. Preferably, the viscosity of the initially modified starch as tested in accordance with the just mentioned test, is reduced by at least about forty percent and preferably at least about fifty percent from that of starch and water. During the acid modification, the mixture of water, starch and acid is maintained at a temperature in the range of about 30° C. and about 60° C. and preferably in the range of about 40° C. and about 50° C.

The acid treatment of the native starch produces an initially modified starch which is characterized by having an eroded or porous exterior surface on the starch granule. It is believed that modification of the native starch through acid modification, results in allowing improved access to the starch in the starch granule by the phosphorus reactant described below. However, excessive modification of the native starch with acid will result in an initially modified starch that is not adapted for phosphorylation. It has been found that modifying the native starch to a fluidity of 40 milliliters and above as measured by techniques known in the art results in an unacceptable initially modified starch for later phosphorylation. The initially modified starch should have fluidity below about 20 milliliters.

After the acid modification, base, such as sodium carbonate and/or sodium hydroxide, is added to the initially modified starch/water/acid mixture. The base neutralizes the acid and increases the pH for the phosphorylation process. Preferably, base is added to the mixture prior to the addition of the phosphorylating reactant. However, the reverse order of addition may be used. It is preferred to increase the pH of the mixture to a pH in a range of between about 11 and about 12 and preferably in a range of between about 11.2 and about 11.8. The pH may be increased to a pH higher than 12 through the addition of such additives as sodium sulfate or sodium chloride to help impede gelation. The precise pH will also be determined by the type of starch starting material and the desired speed of reaction. A second mixture is formed from the original acid treatment mixture and will additionally include the added base and the phosphorylating reactant or reactants. As just mentioned, the pH of the second mixture is in the range of between about 11 and about 12 and the pH is preferably maintained throughout the phosphorylation process by addition of more base from time-to-time. The phosphorylating reactant(s) is (are) added in the desired amounts. Any suitable phosphorylating agent may be added and the particular phosphorylating reactants are regulated in the United States by the Federal Food and Drug Administration when the modified starch is to be used in food or drugs. For example, phosphorus oxychloride may be used. However, the preferred reactants are STMP (sodium trimetaphosphate) in combination with STPP (sodium tripolyphosphate) when the modified starch is to be used in food. If the STMP is used alone, under the Federal Food and Drug Administration regulations, the current maximum residual phosphorus is 0.04% by weight of modified starch. By the addition of STPP with the STMP, the maximum residual phosphorus is 0.4% by weight of dry modified starch. Thus, the mixture of STMP and STPP is preferred for regulatory compliance under current regulations. A particularly useful ratio of STMP to STPP is on the order of about 100:1. The STMP and STPP in combination is added in an amount by weight in the range of between about 3% and about 20% by weight dry starch and preferably in the range of between 5% and about 15%. The percents as expressed herein are based upon the reaction additive being 100% strength. If a weaker than 100% reactant or compound is used, its amount would need to be adjusted to achieve the added percent on a 100% strength basis. The temperature of the second mixture is preferably in the range of between about 30° C. and about 70° C., more preferably in a range of about 35° C. and about 60° C. and most preferably in the range of between about 40° C. and about 50° C. The precise temperature will vary depending upon the type of starting starch used, the time that one wishes to conduct the phosophorylation reaction, the sensitivity of the reaction to change to obtain the desired end modified starch and the additives. A phosphorylation reaction enhancing compound or compounds may be added. Such compounds include sodium chloride and sodium sulfate. It is believe that these ingredients impede gelation allowing a higher reaction pH.

The phosphorylation reaction is conducted as described above for a time period adequate to produce the desired degree of phosphorylation and hence the degree of resistance of the modified starch to digestion as described below. Preferably, the time of the phosphorylation reaction potion of the modification process is in the range of between about 1 hour and about 24 hours.

After the reaction has progressed to the desired degree of phosphorylation and hence resistance, the reaction is neutralized to a pH in the range of between about 6.5 and about 7 by the addition of acid, e.g., hydrochloric acid or sulfuric acid. The decrease in pH substantially stops the phosphorylation reaction from continuing. After neutralizing, the second mixture is removed and washed or washed and then removed to remove the phosphorylating reactants and other wash fluid soluble materials. Preferably, the washing is done with water. Washing is conducted until the desired degree of washout is accomplished. One major constituent for removing from the phosphorylated starch is the phosphorylating reactants to reduce the residual phosphorus to below the regulatory limit. If the modified starch is to be used for nonregulated purposes, e.g., dusting, starch, washing could be eliminated as a step as long as the components that would be washed out do not pose a problem if they remain.

After the phosphorylated starch is washed, it is dried at a suitable temperature for a suitable time to reduce the moisture content to a moisture in the range of between about 5% and about 15% by weight of dry starch. Additional phosphorylation may occur during drying. Preferably, the starch is dried by flash drying at a temperature below about 230° C., inlet air temperature. The particular drying process will determine the required amount of time to achieve the desired moisture reduction. Drum drying may also be used.

The resistance of the phosphorylated starch is measured in accordance with AOAC test 991.43. It is preferred that the resistance of the phosphorylated starch be at least about 40%, preferably at least about 50% and more preferably at least about 70% as measured in accordance with the just mentioned AOAC test.

The above-described invention is illustrated in the below-described example.

### EXAMPLES

Two experiments were conducted to illustrate the difference the crosslinking native starch and crosslinking acid modified native starch. The two experiments were conducted at essentially the same conditions with the exception of the acid treatment step.

### Example 1

1200 grams of native wheat starch were mixed with 1800 grams distilled water to form a slurry. The slurry was maintained with mixing. Peak viscosity was 380 as measure with 8% dry-based solids at 75 RPMs with a 750-gram charge on a Brabender viscometer. Slurry temperature was 72° F., slurry pH 7.41 as measured. Slurry formation time with mixing was one hour. The temperature of the formed slurry was increased and held at a temperature within the range of 105° F. to 110° F. and the slurry pH was 7.4. The slurry was maintained while mixing for two and one-half hours to provide the same time as Example 2 for the acid treatment portion which was 2.5 hours. The pH was adjusted to 11.5 using sodium hydroxide, 120 grams of sodium trimetaphosphate and 1.2 grams of sodium tripolyphosphate were added with the reaction conditions being maintained for 24 hours. The reaction time was 24 hours at a temperature in the range of between 105° F. and 110° F. and the pH was maintained at 11.5 during the 24-hour reaction. After the 24-hour reaction time, sulfuric acid was added to reduce the pH of the slurry to 6.0 for later washing and drying. The time period to reduce the pH to 6.0 was three hours. After the neutralization step, the starch was filtered and washed with 400 milliliters distilled H₂O and oven dried at 140° F. The pH of the final product was 6.5. The product had a moisture content of 1 1.5% and the resistance or total dietary fiber was 83.8% as measured by AOAC 991.43. The viscosity of the product when mixed with water to provide a 8% dry based solids mixed at 75 rpm with a 750 gram charge to the Brabender viscometer, the peak viscosity was less than 10.

### Example 2

All the steps and conditions of Example 1 were used in Example 2 with the exception that during the 2.5 hour hold period of Example 1, the pH was adjusted down with H₂SO₄ to a pH of 1.0, which pH was maintained for a period of 2.5 hours and the slurry was at a temperature of 105° F. to 110° F. Prior to the phosphorylation reaction, and after the acid treatment, the pH of the acid treated starch was adjusted to 7.4 with dilute sodium hydroxide. After this pH adjustment step, the peak viscosity, measured as indicated above, was 220. Thereafter, the phosphorylation reaction, washing, filtering, and drying, was the same as Example 1 as was the reaction pH of 11.5. The resulting modified starch had a resistance or total dietary fiber of 90.9% and a peak viscosity of less than 10.

It can be seen that the use of an acid modified starch allowed, during the same phosphorylation time period, the production of a modified starch with a higher total dietary fiber of approximately 7 percentage points.

1. A modified starch comprising:
a quantity of acid modified starch having said quantity of starch also being phosphorylated to a degree wherein at least about 40% of said quantity of starch being resistant as measured by AOAC test 991.43.

2. The starch is set forth in claim 1 wherein the resistance is at least about 50%.

3. The starch is set forth in claim 2 wherein the resistance is at least about 70%.

4. A method of making a modified starch including;
acid modifying a quantity of starch;
phosphorylating said acid modified starch to a degree wherein at least about 40% of the quantity of phosphorylated starch being resistant as measured by AOAC test 991.43.

5. The method as set forth in claim 4 wherein the acid modified starch prior to phosphorylation has a fluidity of less than about 20 milliliters.

6. The method as set forth in claim 5 wherein the resistance of the starch is at least about 50%.

7. The method as set forth in claim 6 wherein the resistance of said starch is at least about 70%.

8. The method as set forth in claim 4 including adding said modified starch to a food product.
